(19) United States
(12) Patent Application Publication
(10) Pub. No.: US 2011/0279912 A1
(43) Pub. Date: Nov. 17, 2011

(54) Lens Having Circular Refractive Power Profile

(76) Inventor: Werner Fiala, Wien (AT)

(21) Appl. No.: 13/145,476

(22) PCT Filed: Jan. 21, 2010
(86) PCT No.: PCT/AT2010/000019

§ 371 Date: Jul. 20, 2011

(30) Foreign Application Priority Data
Jan. 21, 2009 (AT) A 96/2009

(51) Int. Cl. G02B 3/10

(52) U.S. Cl. 359/721

(57) ABSTRACT

A lens having a circular refractive power profile such that at least one semi-meridian, located between semi-meridians having the minimum and the maximum refractive power of the lens, has a discrete refractive power which is between the minimum and the maximum refractive power of the lens.

### INTRODUCTION

The present invention relates to a lens having a circular refractive power profile.

By contrast with rotationally symmetric lenses, lenses having a circular refractive power profile have different refractive powers in different meridians. At present, only those circular refractive power profiles are known that produce so called toric lenses.

Toric lenses have two different refractive powers in two lens meridians, the so called principal meridians. As a rule, these two lens meridians are orthogonal to one another. The lower of the two refractive powers is generally called “sphere”. The difference between the higher and the lower of the two refractive powers is generally called “cylinder”. Here, the meridians in the refractive powers “sphere” and “sphere+cylinder” can be of circular or else noncircular design, that is to say can be described by the function of an asphere, for example; in this case, in different meridians such surfaces generally also have different asphericities in addition to the different radii (WO 2006/136424 A1). The meridians between the principal meridians have refractive powers that are between the lower and the higher refractive power of the principal meridians.

By way of example, toric lenses are used for the purpose of compensating the ocular astigmatism of an eye; what is involved here can be a corneal or a lenticular astigmatism, or a combination of the two. Toric lenses are, however, also used to correct the astigmatism possibly occurring in other optical systems.

The astigmatism constitutes a wavefront error that can be characterized by the Zernike polynomials

Z(2,2)=\sqrt{6}×R²×cos 2φ or Z(2,−2)=\sqrt{6}×R²×sin 2φ (1)

depending on whether the “sphere” is given at zero or 90° of a coordinate system.

In accordance with the above polynomials, the wavefront error is repeated every 180°, since the functions sin 2φ or cos 2φ are identical for φ and φ+180°.

In FIG. 1 a conventional toric lens is represented in plan view. The toric lens can comprise a lens surface that is toric, and a rotationally symmetric lens surface. However, it can also comprise two toric lens surfaces (“bitoric” in accordance with WO 2006/236424 A1, see above). If the toric lens comprises a toric surface and a rotationally symmetric surface, the difference between the two refractive powers in the principal meridians is accomplished exclusively by the toric lens surface.

In FIG. 2 the corresponding circular refractive power profile of the lens illustrated schematically in FIG. 1 is shown.

In the case of conventional toric lenses, the normal vectors to the lens surface define planes with the lens axis in only two meridians, the principal meridians. These meridians are distinguished in that the derivative is

$$\frac{\partial D}{\partial α} = 0$$

in them, D being the refractive power and α the meridian angle.

In all other meridians, the normal vectors to the lens surface are inclined to the lens axis and do not cut the lens axis.

This state of affairs with conventional toric or bitoric lenses is now described for formal reasons to the effect that the surfaces of such lenses have normal vectors in only four semi-meridians that define planes with the lens axis.

The ocular wavefront error of astigmatism with a cylinder having a dimension of up to one diopter is frequently not corrected, since an eye affected by this wavefront error has an increased depth of focus of the order of magnitude of the cylinder, and the lesser image quality caused by the slight astigmatism can be compensated for by the brain.

The impairment of the imaging by an astigmatic wavefront with a small cylinder can also be held acceptable in other optical systems.

In addition to the wavefront error of astigmatism, there are also other known wavefront errors, for example trefoil, which can be characterized with the Zernike polynomials

Z(3,3)=\sqrt{8}×R³×cos 3φ or Z(3,−3)=\sqrt{8}×R³×sin 3φ (2).

In the case of trefoil, the wavefront error is repeated every 120°. There are also the wavefront errors of tetrafoil, pentafoil, hexafoil, etc. In general, such multifoils can be described by Zernike polynomials of the following type:

Z(n,m)=\sqrt{2(m+1)}×Rⁿ×cos mφ or Z(n,−m)=\sqrt{2(m+1)}×Rⁿ×sin mφ (3).

In the expressions (3), m represents the repetition rate of the wavefront error over 360°. The repetition rate m expresses at which rotation about 360°/m the wavefront surface is equal to the original wavefront surface. The repetition rate m is equal to 2 in the case of astigmatism (bifoil), m=3 in the case of trefoil, m=4 in the case of tetrafoil, etc. The number n in the polynomial Z(n,m) represents the highest power of the unit radius R in the Zernike polynomial; it is not of importance for the present considerations.

The repetition rate in accordance with the above definition is valid not only for surfaces of wavefront errors, but also for corresponding nonrotationally symmetric surfaces such as, for example, lens surfaces, in general.

Multifoils are distinguished in that the whole numbers n and m in the polynomial Z(n,m) or (Zn, −m) have the same value.

In addition, there are yet further wavefront errors that can be described by Zernike polynomials Z(n,m) in which n and m differ.

Conventional toric lenses can compensate only the wavefront error of astigmatism (“bifoil”, m=2). No lenses are known for correcting wavefront errors in the case of which the repetition rate m>2 in accordance with the expressions (3).

In addition to wavefront errors with repetition rates m≧2, there are also wavefront errors with m=1, for example tilting Z(1,1) and Z(1,−1) and coma Z(2,1) and Z(2,−1). Such wavefront errors also cannot be compensated either with conventional rotationally symmetrical lenses or with conventional toric lenses.

### SUMMARY

One goal of the invention is a lens having a circular refractive power profile and with an increased depth of focus.

This goal is achieved with a lens having a circular refractive power profile and which is distinguished in that in at least one semi-meridian located between semi-meridians having the minimum and the maximum refractive power of the lens, it has a discrete refractive power that is between the minimum and the maximum refractive power of the lens.

Lenses of this type are designated below as “discretely toric” (when m=2) and as “discretely supertoric” (when m≠2) and, by comparison with known toric lenses, have an increased depth of focus, as is explained in more detail later.

The lens preferably has only one semi-meridian having the minimum refractive power, and only one semi-meridian having the maximum refractive power, of the lens.

Alternatively, the lens preferably has more than two semi-meridians having the minimum refractive power, and more than two semi-meridians having the maximum refractive power, of the lens.

A discretely supertoric lens with a preferred repetition rate of m=1 is suitable for compensating tilting and/or coma.

A discretely toric lens with a preferred repetition rates of m=2 is suitable, in particular, for compensating astigmatism.

A discretely supertoric lens with preferred repetition rates of m≧3 serves, in particular, for compensating multifoils.

A further object of the invention is a lens having an increased depth of focus that comprises a discretely toric or discretely supertoric lens surface and a rotationally symmetrical lens surface that has in accordance with U.S. Pat. No. 5,982,543 (Fiala) or U.S. Pat. No. 7,287,852 B2 (Fiala) annular zones between which there are situated the optical stages that are larger than the coherence length of polychromatic light.

Consequently, a further preferred embodiment of the inventive lens consists in that it is additionally provided with a radial refractive power profile.

The circular refractive power profile is preferably formed by configuring one surface of the lens, and the radial refractive power profile is formed by configuring the other surface of the lens.

With particular preference, the radial refractive power profile is formed in a way known per se by annular zones with optical stages situated therebetween.

Further features and advantages of the invention emerge from the following description of preferred exemplary embodiments and with reference to the accompanying drawings.

### BRIEF DESCRIPTION OF THE FIGURES

FIG. 1 is a schematic of a conventional toric lens in plan view.

FIG. 2 is a schematic of the circular refractive power profile of a lens in accordance with FIG. 1.

FIG. 3 represents a supertoric lens in plan view. The repetition rate is m=4 for this lens.

FIG. 4 is a schematic of the circular refractive power profile of a lens in accordance with FIG. 3.

FIG. 5 represents an inventive discretely toric lens in plan view.

FIG. 6 is a schematic of the circular refractive power profile of a lens in accordance with FIG. 5.

FIG. 7 represents a supertoric lens in plan view. The repetition rate of this lens is m=3.

FIG. 8 is a schematic of the circular refractive power profile of the lens in accordance with FIG. 7.

FIG. 9 is a schematic of a discretely supertoric lens in accordance with the current invention in plan view. The repetition rate of this lens is m=3; the lens further has at least one surface in the case of which the normal vectors to the lens surface define planes with the lens axis in 18 semi-meridians.

FIG. 10 is a schematic of the circular refractive power profile of the lens in accordance with FIG. 9.

FIG. 11 shows the cross section of an inventive lens with a large depth of focus.

FIG. 12 shows a plan view of a supertoric lens in the case of which the repetition rate m=1.

FIG. 13 is a schematic of the circular refractive power profile of a lens in accordance with FIG. 12.

FIG. 14 shows a plan view of a discretely supertoric lens in accordance with the invention, in the case of which the repetition rate m=1. The lens has at least one surface in the case of which the normal vectors to the lens surface define planes with the lens axis in 8 semi-meridians.

FIG. 15 is a schematic of the circular refractive power profile of a lens in accordance with FIG. 14.

### DETAILED DESCRIPTION

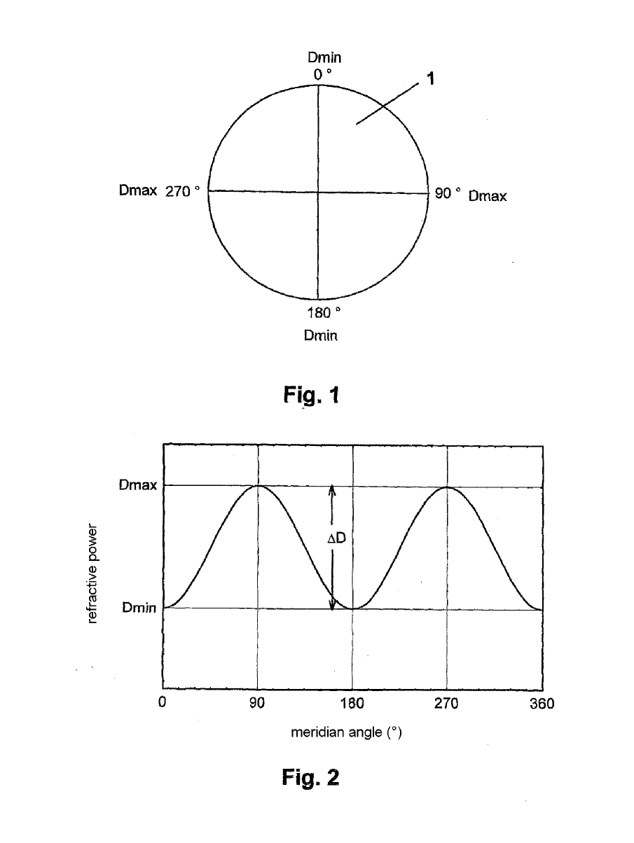

FIG. 1 represents a conventional toric lens 1. The lens has the minimum refractive power Dmin in the principal meridian 0° (=principal meridian 180°), while it has the refractive power Dmax in the second principal meridian 90° (=principal meridian 270°). The refractive power Dmin is usually designated as “sphere”, and the refractive power Dmax as “sphere+cylinder”. The circular refractive power D(α) changes continuously from Dmin to Dmax and is, for example, given by the function

D(α)=Dmin×cos²(α)+Dmax×sin²(α) (4).

Other interpolation functions are possible and may be used, and can be adapted to the profile of the wavefront error. The circular refractive power is to be understood as that refractive power which a rotationally symmetrical lens has and whose front and back radii are given by the radii in that meridian of the toric lens which is under consideration. What is involved here can be a toric lens with a toric surface and a rotationally symmetrical lens, or a toric lens with two toric lens surfaces.

The normal vectors to the toric surface or surfaces of a toric lens are inclined to the lens axis and do not cut the lens axis, except in the principal meridians.

FIG. 2 shows the circular refractive power profile of the lens in accordance with FIG. 1. It is possible to conclude from FIG. 2 that the normal vectors to the lens surfaces define a plane with the lens axis exclusively in the meridian angles α where it holds that

$$\frac{\partial D}{\partial α} = 0. \qquad ( 5 )$$

The above defined repetition rate of the lens or at least of one lens surface of the lens in accordance with FIG. 1 is m=2.

Owing to the fact that the normal vectors to the lens surface or lens surfaces are not inclined to the lens axis and do not cut the lens axis in the principal meridians, the refractive powers in these principal meridians can, for example, be determined by a vertex refractometer. Furthermore, the angle between the principal meridians can be determined by means of suitable apparatus. The meridian refractive powers in positions between the principal meridians cannot, by contrast, be determined in general.

The meridian refractive power in a meridian or semi-meridian of the lens surface in which the normal vector to the lens surface defines a plane with the lens axis is termed “discrete refractive power” below.

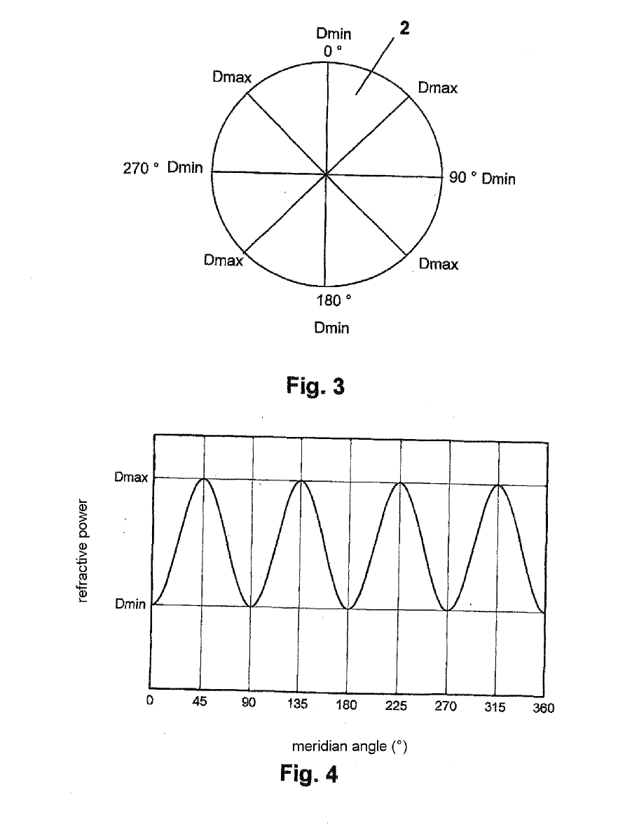

In FIG. 3 a supertoric lens 2 in which the repetition rate m=4 is illustrated in plan view. The circular refractive power profile of the lens is illustrated in FIG. 4.

The lens in accordance with FIG. 4 is suitable for compensating the quadrafoil of a wavefront.

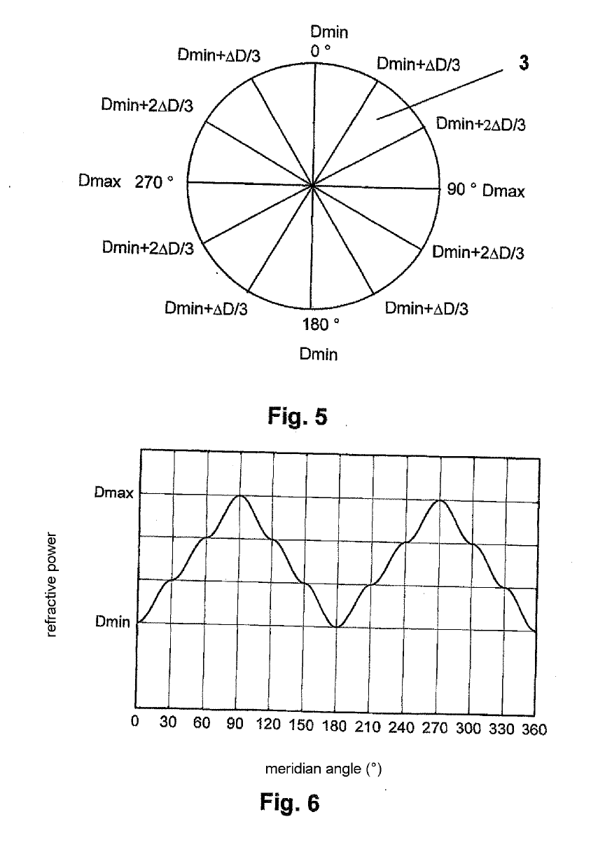

In FIG. 5 an inventive discrete toric lens 3 is illustrated in plan view. The repetition rate of this lens is m=2. This lens differs from conventional toric lenses with the same repetition rate in that it has, in six meridians or 12 semi-meridians, surface elements whose normal vectors define planes with the lens axis, that is to say are not inclined to the lens axis and cut the lens axis. This lens therefore has discrete refractive powers in six meridians or in 12 semi-meridians.

The circular refractive power profile of the lens in accordance with FIG. 5 is illustrated in FIG. 6. As may be seen, the lens has discrete refractive powers in six meridians. The lens is therefore multifocal and has a depth of focus that is larger than a rotationally symmetrical lens of the same diameter with smooth surfaces.

If the minimum refractive power Dmin of the lens in accordance with FIG. 5 is, for example, 20 diopters, and the maximum refractive power Dmax is 23 diopters, this lens has discrete refractive powers of 20, 21, 22 and 23 diopters.

The assessment of the imaging quality of discretely toric or supertoric lenses is served by estimates of the optical wavelength errors in defocus positions:

As stated in “W. Fiala, J. Pingitzer, Analytical approach to diffractive multifocal lenses”, Eur. Phy. J AP 9,227-234 (2000)”, the optical wavelength error PLE in a defocus position of ΔD diopters is:

$$PLE = \frac{Δ D \times {B}^{2}}{8} . \qquad ( 6 )$$

B is the diameter of a lens in equation 6.

If, two discrete refractive powers are present at a spacing of 1 diopter, as in the above example), the mean defocus ΔDₐᵥ is equal to 0.5 diopters. The mean optical wavelength error PLEₐᵥ is therefore given by:

$${PLE}_{av} = \frac{0.5 \times {B}^{2}}{8} . \qquad ( 6 ' )$$

The optical wavelength error in both refractive powers is half a wavelength, that is to say approximately 0.28 μm (see W. Fiala, J. Pingitzer, loc. cit.) in the case of diffraction lenses of the same relative intensity in the zeroth and first diffraction orders. It is known that the imaging quality of such bifocal lenses is satisfactory.

Therefore, if a wavelength error of PLEₐᵥ=0.28 μm is allowed, equation 6′ yields a lens diameter of 2.12 mm. This means that given the above assumptions, the lens in accordance with FIG. 5 has a continuous depth of focus of at least 3 diopters up to a diameter of 2.12, it being possible to designate the lens as “omnifocal” in this region.

In the case of circular lenses, a contrast reversal of

$${PLE}_{KU} = \frac{λ \sqrt{2}}{2} \qquad ( 7 )$$

occurs for a wavelength error of PLE_{KU}. If a wavelength error in accordance with equation 7 is allowed, the permissible diameter of the lens is increased to 2.5 mm.

This shows that discretely supertoric lenses in accordance with the present invention are multifocal given relatively large lens diameters, and have a large depth of focus, that is to say are omnifocal, given relatively small diameters.

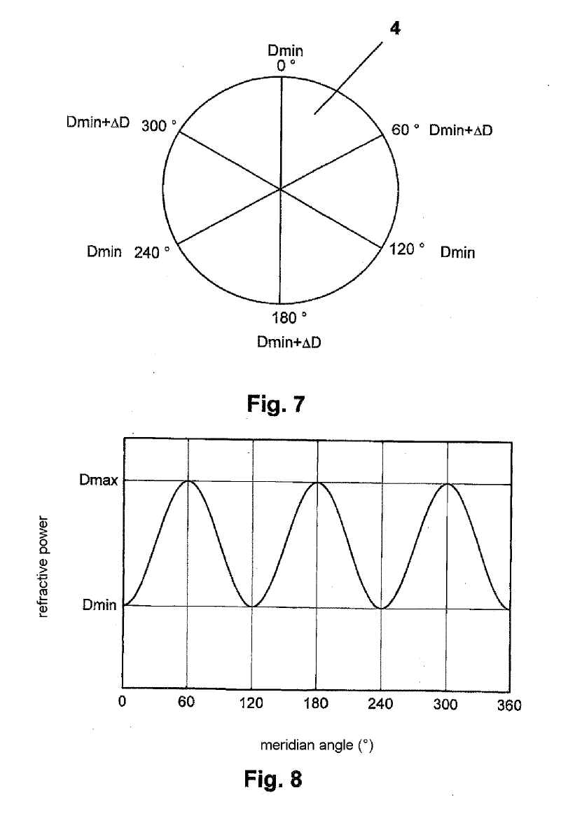

A supertoric lens 4 is illustrated in plan view in FIG. 7. The repetition rate of this lens is m=3. The circular refractive power profile of the lens in accordance with FIG. 7 is illustrated in FIG. 8. A lens in accordance with FIG. 7 is suitable for compensating the trefoil of a wavefront.

As may be seen, a lens in accordance with FIG. 7 has discrete refractive powers only in semi-meridians. Thus, the lens in accordance with FIG. 7 has the refractive power Dmin in the semi-meridians 0°, 120° and 240°, and the refractive power Dmax=Dmin+ΔD in the semi-meridians 60°, 180° and 300°.

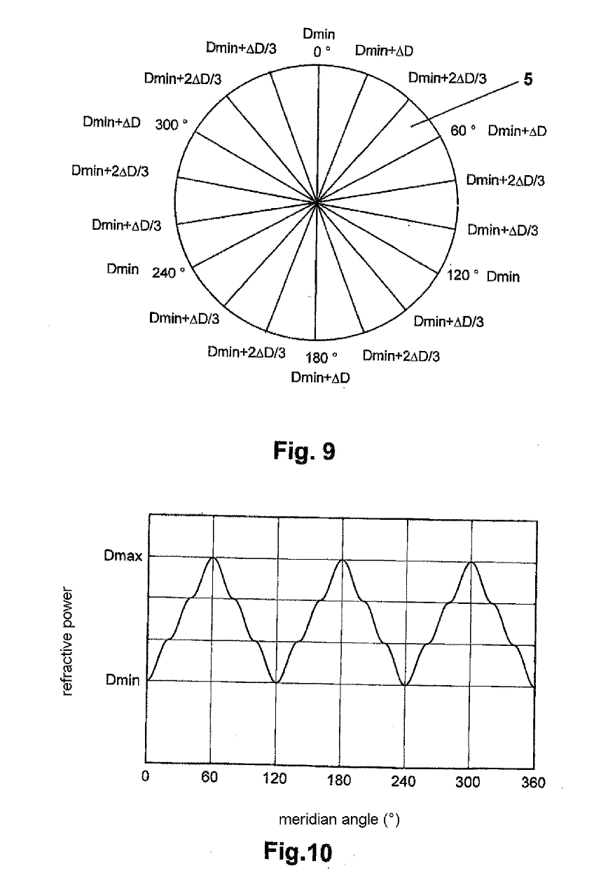

FIG. 9 shows a discretely supertoric lens 5 in plan view. The repetition rate of this lens is m=3. The lens has discrete refractive powers in a total of 18 semi-meridians. The circular refractive power profile of the lens in accordance with FIG. 9 is illustrated in FIG. 10. The statements made in conjunction with the discussion of the imaging quality of a lens in accordance with FIG. 5 are valid mutatis mutandis for this lens. The lens is multifocal given large diameters, and omnifocal given small diameters.

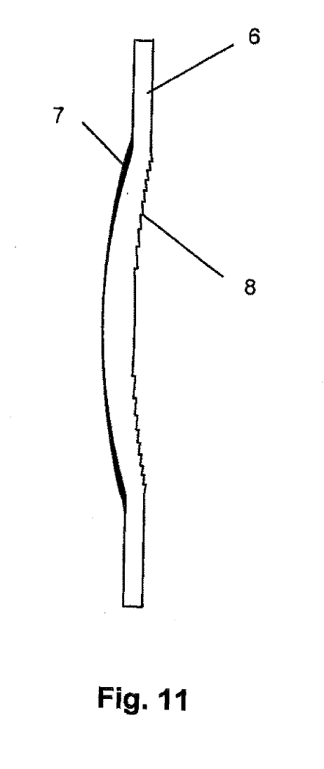

In FIG. 11 a further lens 6 is illustrated in cross section. The lens has a front surface 7 with a circular refractive power profile, for example toric, discretely toric, supertoric or discretely supertoric, as previously discussed, and a rear surface 8 with a radial refractive power profile, for example subdivided into annular zones and with optical stages between the individual annular zones, as described in U.S. Pat. No. 5,982,543 (Fiala) and U.S. Pat. No. 7,287,852 B2 (Fiala).

The circular and the radial refractive power profile can respectively be formed both by the configuration of one or the other surface 7, 8, and also by a combination of the surfaces 7, 8.

As a result of the combination of a circular and a radial refractive power profile, this lens also has a large depth of focus for large diameters, that is to say even for large diameters it has the property of being omnifocal.

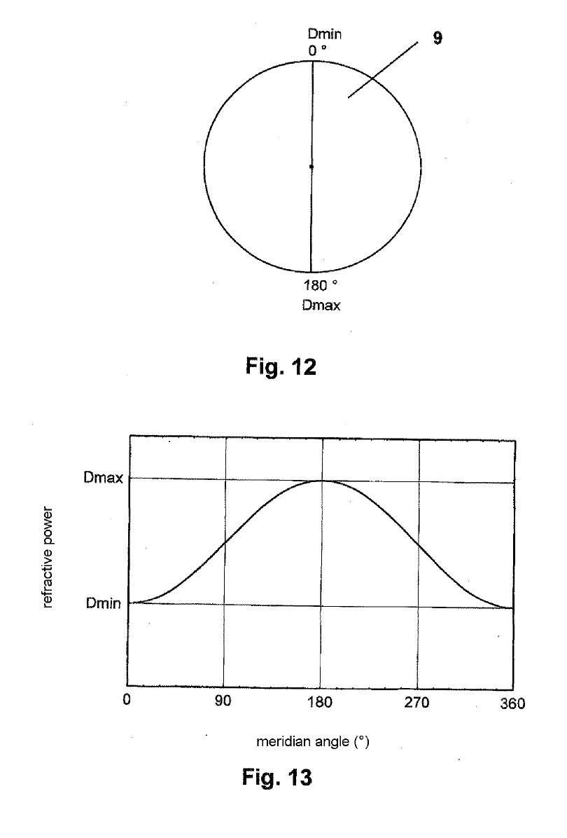

In FIG. 12 a further lens 9 is illustrated in plan view. The circular refractive power profile of the lens in accordance with FIG. 12 is illustrated in FIG. 13.

As may be seen, the repetition rate of the lens in accordance with FIG. 12 is m=1. In the semi-meridian 0°, the lens has a discrete refractive power Dmin, while in the semi-meridian 180° the lens has a discrete refractive power of Dmax.

Lenses in accordance with FIG. 12 are suitable for correcting the wavefront error of tilting and coma.

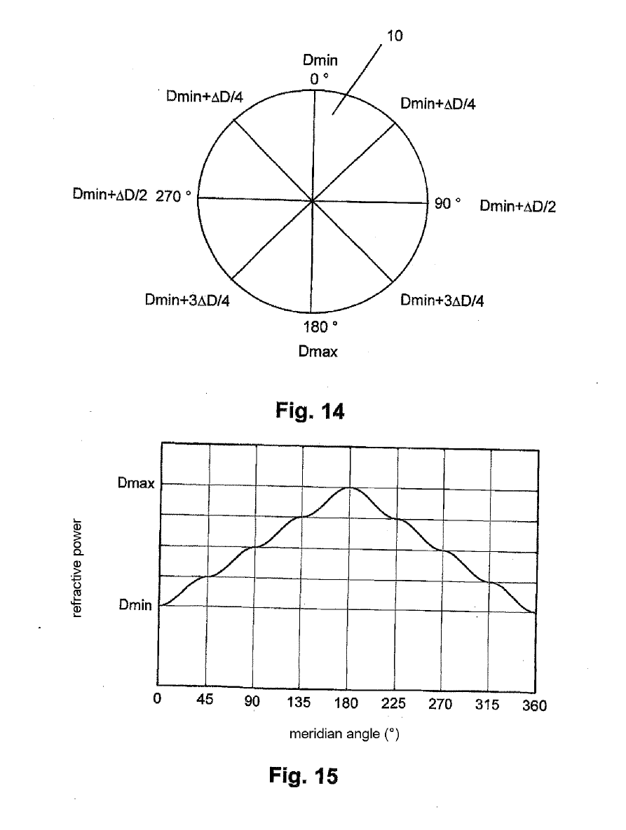

Finally, in FIG. 14, a discretely supertoric lens 10 is illustrated in plan view. The repetition rate of this lens is m=1. The lens has discrete refractive powers in 8 semi-meridians. The circular refractive power profile of the lens in accordance with FIG. 14 is illustrated in FIG. 15.

The lens has a large depth of focus even for large diameters when the surface of a lens in accordance with FIG. 14 is combined with a surface 8 subdivided into zones in accordance with FIG. 11. What has been said in conjunction with the lens in accordance with FIG. 5 applies mutatis mutandis.

Lenses with a circular refractive power profile in accordance with the current invention can be manufactured with the aid of modern lens lathes that are suitable for producing freeform surfaces (for example, EPT Optomatic, Rigeo, NL, or Modell Optoform, Precitech, USA).

The invention is not limited to the embodiments illustrated, but comprises all variants and modifications that come within the scope of the appended claims.

What is claimed is:

1. A lens having a circular refractive power profile comprising at least one semi-meridian located between semi-meridians having the minimum and the maximum refractive power of the lens, wherein the at least one semi-meridian has a discrete refractive power that is between the minimum and the maximum refractive power of the lens.

2. The lens as claimed in claim 1, wherein the lens has only one semi-meridian having the minimum refractive power, and only one semi-meridian having the maximum refractive power of the lens.

3. The lens as claimed in claim 1, wherein the lens has more than two semi-meridians having the minimum refractive power, and more than two semi-meridians having the maximum refractive power of the lens.

4. The lens as claimed in claim 1, wherein a repetition rate of the lens' circular refractive power profile is equal to 1.

5. The lens as claimed in claim 1, wherein a repetition rate of the lens' circular refractive power profile is equal to 2.

6. The lens as claimed in claim 1, wherein the repetition rate of the lens' circular refractive power profile is greater than or equal to 3.

7. The lens as claimed in claim 1, wherein the lens is additionally provided with a radial refractive power profile.

8. The lens as claimed in claim 7, wherein the circular refractive power profile is formed by configuring one surface of the lens, and the radial refractive power profile is formed by configuring the other surface of the lens.

9. The lens as claimed in claim 7, wherein the radial refractive power profile is formed by annular zones with optical stages situated therebetween.

10. The lens as claimed in claim 1, wherein the lens is an intraocular lens.

11. The lens as claimed in claim 1, wherein the lens is a contact lens.

12. The lens as claimed in claim 1, wherein the lens is a lens of an optical device.
